(19) United States
(12) Patent Application Publication
(10) Pub. No.: US 2005/0233228 A1
(43) Pub. Date: Oct. 20, 2005

(54) Grayscale lithography methods and devices

(76) Inventors: John J. Fijol, Shrewsbury, MA (US); Eugene E. Fike, Amesbury, MA (US)

Correspondence Address: Thomas E. Anderson;Hunton & Williams LLP, 1900 K Street, NW, Washington, DC, 20006-1109, US

(21) Appl. No.: 10/826,663

(22) Filed: Apr. 16, 2004

(51) Int. Cl. G03G 16/00

(52) U.S. Cl. 430/50

(57) ABSTRACT

In one aspect, the invention relates to a method of fabricating a three-dimensional structure from an etchable substrate. The method includes steps of specifying a unit cell size for a plurality of unit cells. Each unit cell corresponds to an area on a mask. Generating a plurality of measurement values is another step of the method. Each measurement value corresponds to a portion of the structure. Further, each measurement value is associated with a specific unit cell. The steps of the method also include converting the plurality of measurement values to a plurality of unit cell fill factor values and generating a gray tone data set in response to the unit cell fill factor values. The gray tone data set includes a plurality of distinct rectangular areas and distinct square areas, each distinct area corresponding to a unique gray tone level.

### FIELD OF THE INVENTION

The invention relates generally to the field of lithography techniques for device fabrication. Specifically, the invention relates to lithographic techniques using a continuum of grayscale tones to control device fabrication.

### BACKGROUND OF THE INVENTION

Fabricating objects having complex surface, structural, and optical characteristics raises numerous technical challenges. Many of these challenges are independent of the object's size. However, as attempts are made to fabricate increasingly smaller structures, the fabrication challenges increase. In order to facilitate the fabrication of small scale objects, various semiconductor techniques have been adapted to create three-dimensional structures on suitable substrates. The need for appropriately sized opto-electronic devices and optical fiber based components has fueled interest in this area.

Designing a specialized structure, such as an electric circuit or optical component, demands a high degree of precision in the fabrication process. This precision enables the fabrication of parts that comply with the specific tolerances required by a given application. If the fabrication process cannot accommodate the requisite design tolerances not only is the design effort wasted, but the development of the structures and any derivative applications of those structures remains unattainable.

Currently, small scale structures requiring a high degree of smoothness or possessing a low tolerance for surface defects are difficult to produce using conventional methods. A need therefore exists for techniques that facilitate the fabrication of these complex structures. Further, techniques are sought that provide improved surface smoothness and increased surface complexity without significantly increasing fabrication costs.

### SUMMARY OF THE INVENTION

In one aspect, the invention relates to a method of fabricating a three-dimensional structure from an etchable substrate. The method includes the step of specifying a unit cell size for a plurality of unit cells. Each unit cell corresponds to an area on a photolithographic mask. Generating a plurality of measurement values is another step of the method. Each measurement value corresponds to a portion of the structure. In one embodiment, measurement values correspond to height measurements taken at specific points along the surface of the three-dimensional structure. Further, each measurement value is associated with a specific unit cell. The steps of the method also include converting the plurality of measurement values to a plurality of unit cell fill factor values and generating a gray tone data set in response to the unit cell fill factor values. The gray tone data set includes a plurality of distinct rectangular areas and distinct square areas, each distinct area corresponding to a unique gray tone level. As a result, the method also includes adjusting the size and number of square and rectangular areas to increase the available number of unique gray tone levels; and creating the mask in response to the gray tone data set. In this method, at least a portion of the plurality of rectangular and square areas are disposed on the mask.

In one embodiment of this aspect, the method further includes the step of etching a pattern of non-overlapping three-dimensional photoresist volumes disposed on the substrate, the pattern of photoresist volumes generated in response to the areas on the photolithographic mask. In another embodiment, the measurement values include height values measured at specific points on a surface of the three-dimensional structure. The step of converting the plurality of measurement values uses selectivity data, photoresist contrast data, and exposure data in one embodiment. The step of adjusting the size and number of square and rectangular areas can include calculating at least a portion of the rectangular and square geometries that can fit within a unit cell. In one embodiment, the method includes eliminating rectangular and square areas that exceed a specified aspect ratio. In another embodiment, the method includes eliminating rectangular and square areas having a dimension smaller than a minimum spot size of a mask write tool. The photoresist volumes are mesa structures in one method embodiment. Further, the gray tone data set includes shapes that incrementally differ by one unit of area in one embodiment. In one embodiment, the gray tone data set includes shapes that increase monotonically in area by increasing the length or width of the shape by one unit quantity. In another embodiment, all distinct quadrilateral areas that fit within a unit cell are associated with a graytone level.

In another aspect, the invention relates to a method of increasing available graytone levels for use in a lithographic process. The method includes the step of determining a unit cell size in response to a designed part geometry. Generating a set of distinct quadrilateral areas such that each area fits within a unit cell is another step in the method. The method also includes the step of removing redundant quadrilateral areas from the set, associating each graytone level with a distinct quadrilateral area; and correlating each graytone level with a distinct unit cell fill factor.

In one embodiment, the set of distinct quadrilateral areas includes a first set of square areas and a second set of rectangular areas. In another embodiment, the set of distinct quadrilateral areas includes shapes that incrementally differ by one unit of area. The quadrilateral areas having a dimension smaller than the minimum spot size of a mask write tool are removed from the set in one embodiment of the method.

In an additional aspect, the invention relates to a lens fabricated using a grayscale lithographic process. The process includes generating a pattern of three-dimensional photoresist structures on a substrate using a mask. The mask includes a plurality of regions populated by rectangular and square areas. The method includes etching the photoresist and substrate, thereby generating a lens. In one embodiment, the lens has a lens diameter ranging from about 5 μm to about 1 cm. In another embodiment, the aspect ratios of the rectangular and square areas are restricted to reduce surface defects in the lens. In a further embodiment, the required profile of the lens surface determines the number and size of the distinct square and rectangular areas disposed on the mask. In yet another embodiment, at least one of the regions is substantially concentric. In one embodiment, only rectangular areas are used.

In yet another aspect, the invention relates to a diffraction grating produced using a lithography process. The lithography process includes the step of generating a mask having a periodic arrangement of a plurality of selectively filled unit cells, each unit cell partially filled with a fractional area selected from a set of square and rectangular areas, each area corresponding to a gray tone level. The process also includes depositing a photoresist layer on a substrate, exposing the photoresist layer to radiation selectively transmitted by the areas of the mask, developing the photoresist layer such that a periodic arrangement of photoresist mesa structures result and etching the mesa structures and substrate. In one embodiment, the grating spacing ranges from about 5 μm to about 1 cm. In one embodiment, only rectangular areas are used

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIGS. 1A and 1B are mask portions illustrating some grayscale lithography fill elements;

FIG. 2 is a data plot depicting the relationship between graytone levels and an available set of square areas;

FIG. 3 is a data plot depicting the relationship between graytone levels and an augmented set of available areas according to an illustrative embodiment of the invention;

FIG. 4 is a schematic representation depicting a grayscale mask portion with four different graytone levels according to an illustrative embodiment of the invention;

FIG. 5 is a schematic representation depicting a grayscale mask for a tapered structure according to an illustrative embodiment of the invention;

FIG. 6 is a schematic diagram depicting a mask design method according to an illustrative embodiment of the invention;

FIG. 7 is a schematic diagram depicting a grayscale level development method according to an illustrative embodiment of the invention;

FIG. 8 is a schematic representation depicting a grayscale mask for a lens structure according to an illustrative embodiment of the invention;

FIG. 9 is a surface profile of a lens structure fabricated according to an embodiment of the invention;

FIG. 10 is an arrangement of photoresist structures fabricated using an embodiment of the invention; and

FIG. 11 is a schematic diagram depicting an exemplary fabrication method for a lens structure according to an illustrative embodiment of the invention.

### DETAILED DESCRIPTION

The presently preferred and alternative embodiments of the invention, including the best mode for practicing the invention known at this time, are now described in detail in connection with the accompanying drawings. It is, however, expressly noted that the present invention is not limited to these embodiments, but rather the intention is that modifications that are apparent to the person skilled in the art and equivalents thereof are also included.

The techniques disclosed herein extend the scope of grayscale lithography fabrication methods. Accordingly, the complexity and types of structures that can be fabricated are likewise increased. Structures that demand low levels of surface defects and/or strict control over the repeatability of periodic structural features can be fabricated using the teachings of the claimed invention. Specifically, microlenses that require increased levels of smoothness and gratings that require precise repeating structures can be fabricated using the techniques disclosed below. Grayscale lithography provides the underlying techniques that enable the fabrication of the various structures discussed below.

In part, grayscale lithography uses a mask, a photoresist layer, a substrate, and a source of electromagnetic radiation. These elements are used in combination to transform the characteristics of the photoresist disposed on the substrate. After this transformation and the removal of select photoresist portions, an etch process is used to shape the substrate. The term grayscale refers to the pattern of shapes that form part of the mask and the resultant electromagnetic radiation intensity pattern. The grayscale mask pattern is used to control the photoresist's exposure to light and contributes to the shape of the desired three-dimensional structure.

In the context of imaging terminology, a grayscale is a continuum of varying shades of gray that range from white to black. A gradient of tones exists between the white and black extremes of the scale. A graytone number can be associated with each division of the scale. For example, if a grayscale spans a continuum of one hundred tones, graytone number one may correspond to “white” while graytone number one hundred may represent the “black” extreme, or vice versa.

Theoretically, when discussing a grayscale as an abstraction, an infinite number of graytones are available. Thus, a grayscale made up of five hundred graytones or some other larger number is possible. Increased numbers of graytones reflect finer divisions between the individual tonal levels. However, computational limits and the extent that different tones are mutually indistinguishable to a viewer limit the choice of the number of available graytones in a conventional photography or imaging application. As will be discussed in more detail below, increasing the number of available graytones becomes complex and subject to additional constraints when applying the concept to lithographic fabrication techniques.

In the context of grayscale lithography an arrangement of regions are disposed on a mask in a particular pattern. This pattern controls how the mask transmits light to a photoresist layer during exposure. The pattern of selectively filled regions on the mask acts like a filter when coupled with an optical system, such as a stepper. In order to provide a coordinate system relative to the mask surface, a uniform grid of unit cells can be imposed. This grid of unit cells spans some or all of the surface of the mask. These uniform regions are selectively filled with a substantially non-transmitting material such that filled regions are below the resolvable limit of the optical system. Consequently, these selectively filled unit cells act as a diffraction grating and the parameters of this grating are selected such that only energy in the zeroth diffraction order passes through the stepper. All higher orders are diffracted to angles which exceed the entrance pupil of the optical system. This allows the optical system to act as a spatial filter, transmitting only intensity values. It is this spatial filtering that results in the grayscale pattern that gets projected onto the photoresist layer.

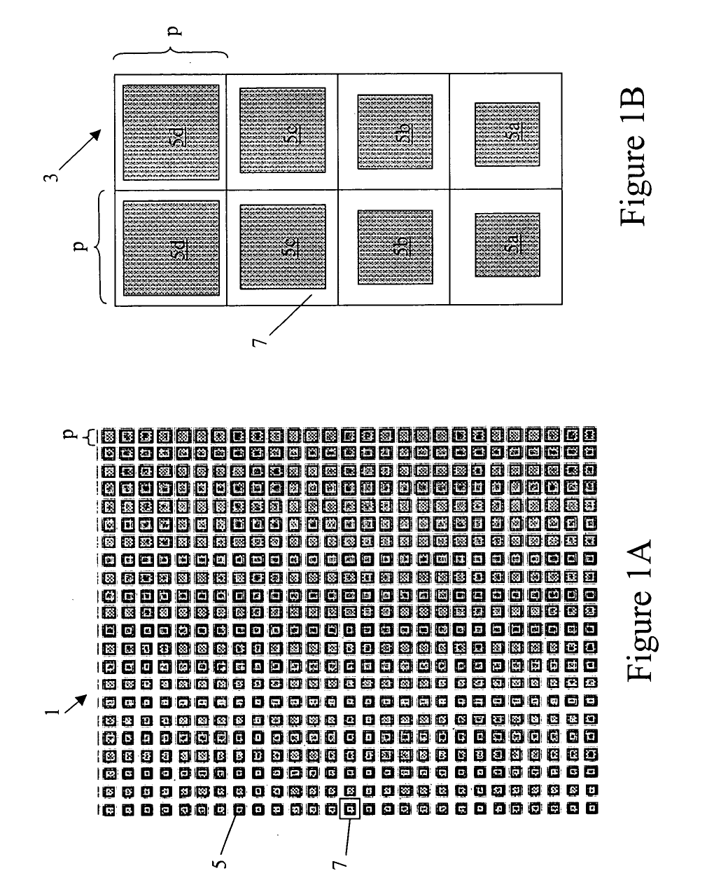

Each unit cell of the grayscale mask can contain a selectively filled region corresponding to a certain fill fraction. This concept is illustrated in the mask portions 1, 3 shown in FIGS. 1A and 1B. In these exemplary mask portions, a square region (5 generally) is centered in the unit cell 7. In this embodiment, the unit cells 7 are squares with side length p. In FIG. 1A, a mask portion 1 for fabricating a tapered structure is shown.

In FIG. 1A, the square unit cells are shown as increasingly full when moving left to right across the mask portion 1. In the resultant taper structure, this gradient would correspond to the increasing surface heights that form the tapered wedge. This tonal gradient illustrates some of the grayscale ideas discussed above. Low fill fraction corresponds to a high degree of open area. Thus, small square areas on the mask correspond to low gray scale numbers and high transmission of optical radiation, which results in thinner photoresist thickness after exposure and development of the resist layer. Conversely, large square areas on the mask correspond to high gray scale numbers and lower transmission, which results in thicker photoresist regions.

In FIG. 1B, a smaller portion 3 of a larger mask is shown. The filled regions 5a, 5b, 5c, and 5d are all shown as squares. In one embodiment, these square fill elements are disposed within the center of a unit cell 7. Each of these squares 5a, 5b, 5c, and 5d has a variable side dimension s that is 1/10 larger than the previous square. The ratio of the area of a given square area (s²) compared with the area of the unit cell (p²) gives that unit cell's fill fraction.

The differing fill fractions of the unit cells 7 control the flow of light through the mask. In one embodiment, each graytone level corresponds to one selectively filled unit cell. However, in another embodiment a collection of unit cells having the same fill fraction may designate one distinct graytone level. Typically, some unit cells are left unfilled or completely filled as appropriate for the design of a given structure.

FIG. 1B illustrates a phenomenon that aspects of the invention are designed to improve upon. In FIG. 1B, it is clear that there are only a finite number of square areas that can fit within a unit cell. As such, the number of available graytones is limited by the cardinality of the set of square areas that fit within a unit cell. Increasing the unit cell's area expands the range of available square shapes that in turn correspond to individual grayscale levels. There are other lithographic constraints that affect which values p can range over. Consequently, the set of unit cell sizes is constrained.

As discussed above, when initially designing a mask, a grid made up of unit cells is used to section a mask into fillable regions. Filling these unit cells to a varying fractional degree with a substantially opaque material establishes the light intensity that is transmitted to a photoresist. Thus, the region of material disposed within a unit cell must always be less than or equal to the unit cell area. It is desirable for the unit cell dimension to be less than what can be resolved by the stepper or other optical projection system being used for lithographic fabrication process. Reimer et al. (See Reimer et al. “One-level gray-tone lithography—mask data preparation and pattern transfer,” SPIE Vol. 2783, p. 71, 1996. The disclosure of which is herein incorporated by reference in its entirety.) showed that it is desirable for the following relationship to hold:

$$p \leq \frac{λ}{{N}_{A} ( 1 + σ )} \qquad ( 1 )$$

where p is the unit cell dimension as projected on the photoresist layer, λ is the stepper wavelength, N_{A} is the stepper numerical aperture, and σ is the stepper coherence parameter. In various embodiments, a first unit cell dimension can range from about 350 nm to approximately 650 nm. The electromagnetic radiation wavelength can also be selected from of a range of about 248 nm to about 157 nm in some embodiments. Other values for the variables used in Equation 1 known to those skilled in the art are also included.

As alluded to above, there are often countervailing factors when choosing the size of the unit cell dimension p. Selecting a larger value of p enables a wider range of fill element areas. In turn, this increases the number of available graytone levels. However, using larger p values increases the surface roughness associated with resolved pixelation since Equation 1 is not satisfied. Therefore, simply increasing the p value does not increase graytone levels without introducing new negative effects. Further, larger p values lower the resolution of the grid of unit cells. This reduces the lateral resolution for the final parts and restricts the complexity of a fabricated part's final geometry in the plane of the photoresist layer.

Increasing the number of graytones available during the fabrication process allows for smoother transitions between the varying heights of the photoresist structures. Accordingly, finer gradations and subtler changes in the surface of the final part are possible when the photoresist and substrate are etched. If there are abrupt changes in the surface profile of the object being fabricated, additional graytone levels are required to accommodate the discontinuities in surface height. Thus, the amount of available graytone levels determines the types and complexity of the parts that can be produced. Given that simply increasing the unit cell size causes pixelation problems, other approaches must be developed to increase the number of available graytones.

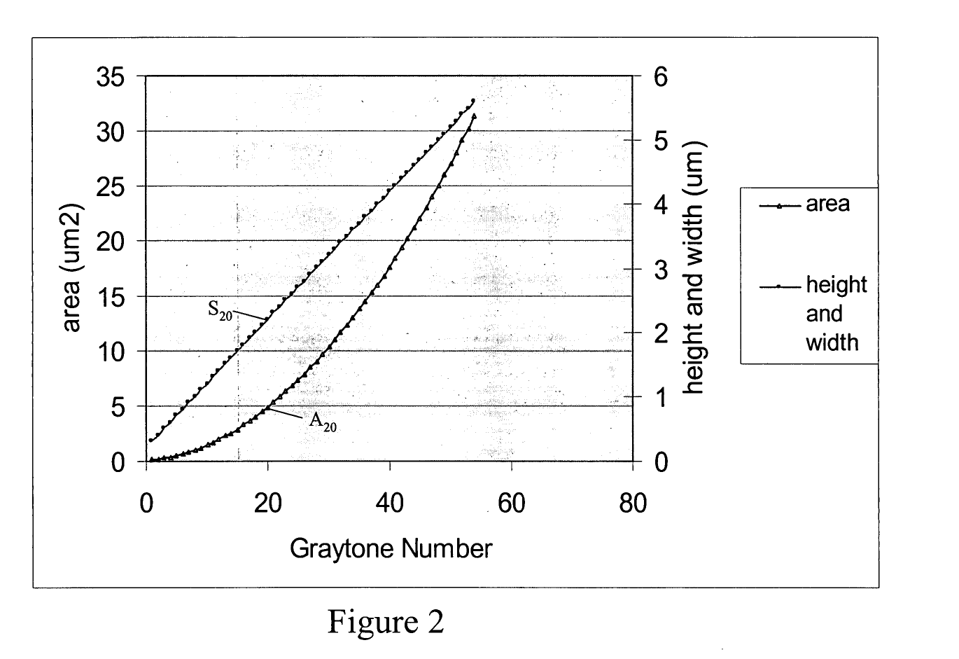

FIG. 2 is a plot relating graytone number vs. area of unit cell fill elements for a graytone mask designed using square fill elements. In this plot, square fill elements such as those regions illustrated in FIGS. 1A and 1B are considered. The grayscale mask design was prepared for use with a 10× i-line (365 nm) stepper. For the data shown, a unit cell size of 5.6 μm, an address size of 0.1 μm, and a minimum feature size of 0.3 μm were used. The address size corresponds to the dimension that the mask write tool can delineate on the mask.

The dimensions of the data are described at the mask level. These dimensions are reduced by 10× when projected through the 10× stepper on to a photoresist coated substrate. The plot shows the height and width of each square fill element. Since the fill elements are squares having a variable side dimension s, the plot depicts fill elements having equivalent lengths and widths. The fill element area is plotted on the primary (left) axis and the height and width are plotted on the secondary (right) axis. The parabolic shape of the area curve follows from the increasing area s² of the square fill elements. The linear plot of height (h), and width (w) follows because h=w=s for increasing s values. That is, increasing s values are plotted against increasing graytone numbers. This is a linear relationship. However, the set of graytone numbers is restricted by the rate at which the area curve reaches its maximum at the unit cell area.

The details of FIG. 2 can also be understood by considering an exemplary data point. The different square fill elements of the figure correspond to individual grayscale numbers. An exemplary square fill element with a square side length S₂₀ approximately equal to 2.23 μm is shown. The s value is obtained from the secondary axis. This square fill element corresponds to graytone number 20. The area A₂₀ of the fill element is approximately 5 μm². This area value is obtained from the primary axis. Thus, the plot indicates that as the area curve increases by s², the range of available graytone numbers is accordingly narrowed.

When the s value of a given square fill element reaches the unit cell dimension p, a maximum area is obtained because the square fill element area and the unit cell area are equal at that point. Evaluating the plot at this point indicates that the use of square elements limits the number of graytone levels to approximately 54 levels. This limitation exists due to the fact that the value of s for each consecutive square element must be incremented by one address size.

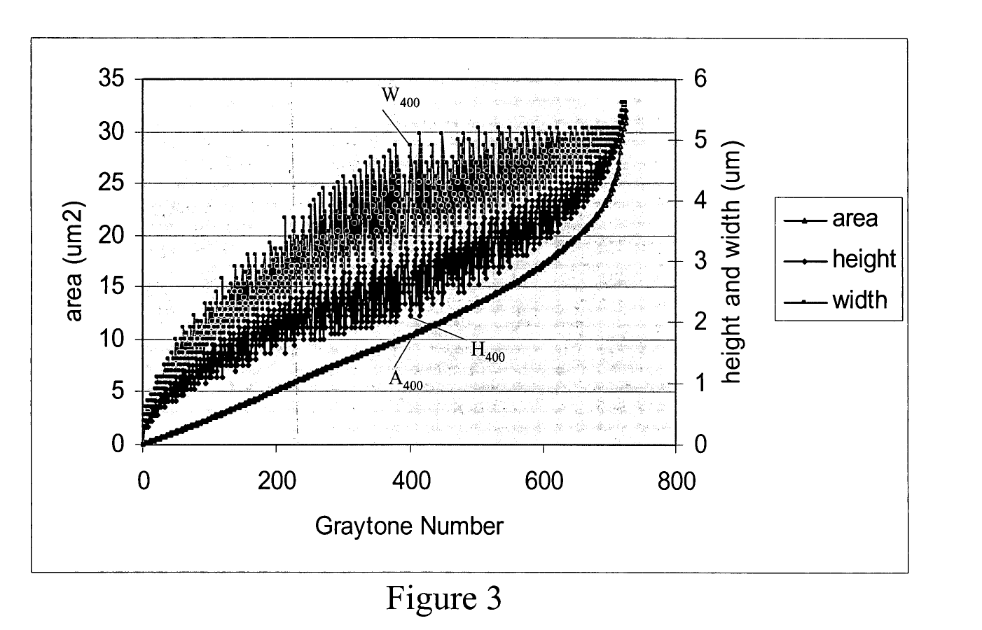

FIG. 3 illustrates the advantages of the invention over the example shown in FIG. 2. In FIG. 3, graytone number is plotted against the area of the unit cell fill elements. However, in this illustrative embodiment an area adjustment process was applied. This process uses square and rectangular areas to increase the number of suitable fill elements. The details and techniques of this process are discussed in more detail below. The fill elements in this embodiment are quadrilaterals of varying areas, generally squares and rectangles. In some embodiments, only rectangles are used.

In the example shown in FIG. 3, the grayscale mask incorporating the differently sized quadrilateral elements was designed for use with a 10× i-line (365 nm) stepper. The input parameters include a unit cell size of 5.6 μm, an address size of 0.1 μm, and a minimum feature size of 0.3 μm. As was the case with FIG. 2, these dimensions are scaled at the mask level. Therefore, the units are reduced by a factor of ten when projected through the 10× stepper on to a photoresist-coated substrate. The plot also shows the height and width of each square and rectangular fill element. In some embodiments, square fill elements are not used when they span the same area as a rectangular fill element.

Each unique quadrilateral area corresponds to a different gray tone level. As shown, graytone number 400 has an associated rectangular area A₄₀₀. The rectangular fill element associated with this number and area has a height H₄₀₀ and a width W₄₀₀. Generally, the various H and W values for the different fill elements are increasing in the plot when moving from left to right. However, the values of H and W do not increase monotonically and instead exhibit oscillations around the generally increasing trend. As shown in FIG. 2, it is the area defined by the product of H and W that is monotonically increasing. To generate a set of data such as shown in FIG. 2, all values of H and W that are integer multiples of the address size, but less than or equal to the unit cell dimension p are used to calculate a table. The table includes all possible quadrilateral fill elements that will fit within the unit cell. This table is then arranged in order of increasing area in one embodiment. Next, any quadrilateral elements with redundant areas are removed from the table. Finally graytone numbers are assigned to the remaining quadrilateral elements starting with the smallest element and ending with the largest element. Thus, larger fill elements are being generated as increasing graytone numbers are assigned to larger unit cell fill fractions. As the plot illustrates, only a small fraction of the quadrilateral elements are square with equal values of H and W.

Additionally, in this embodiment the width values are chosen to be greater than or equal to the height values. This is reflected in the exemplary figure because the plot of the width values is above the height value plot. When the width values are selected to be larger than the height values, varyingly sized rectangles oriented in substantially the same directions based on their aspect ratios result. Rectangular fill elements with height values larger than the width values could have been chosen and would be oriented orthogonal with respect to those in FIG. 3. However, each rectangular element and has an orthogonal counterpart of equal area which represents a redundant grayscale level and therefore only one orientation is utilized in the final set of data. A preferred orientation of all the quadrilateral elements can be selected in some embodiments in order to simplify the steps used to calculate fill element dimensions. However, any specific fill element orientation is not a requirement of the invention.

In FIG. 3, the fill element area is plotted on the primary (left) axis and the height and width are plotted on the secondary (right) axis. By selectively augmenting fill element areas, the number of graytone levels is increased from 54 levels, as plotted in FIG. 2, to 725 graytone levels as shown in FIG. 3. Increasing the number of graytones provides improved part smoothness and enables the fabrication of more complex surface geometries. Generating a distinct set of areas that correspond to specific fill fractions and graytone levels are discussed in more detail below.

The choice of different square and rectangular areas controls light passing through the mask. A grayscale mask is designed to project light of variable intensity based upon the position of the substantially opaque regions of the mask. These substantially opaque regions are sized to correspond to a specific fill fraction. Theoretically, any type of shape can be chosen to achieve a particular fill fraction that corresponds to a unique grayscale level. By choosing fill elements that are not resolved by the lithography projection system, the projected image that results is a simple two-dimensional intensity pattern containing only zeroth order diffraction components.

However, there are practical limitations in the fabrication of photolithographic masks that restrict the options for choosing fill elements. The available mask layout and fabrication tools have evolved from the semiconductor industry. These tools use designs based on Manhattan geometries in which all features on the masks are comprised of polygons, and typically are rectangular polygons. In addition all vertices of the polygons must map to points on a grid. Finally, each feature in a non-grayscale mask is represented by a single polygon. In a grayscale mask individual features may be represented by many thousands of polygons that are relatively much smaller in size. This results in a very substantial increase in the size of data files and equipment time required to fabricate grayscale masks. In order to keep mask fabrication times and the size of data files within practical limits, simple structures such as squares and rectangles must be used as fill elements and only a single fill element must be used per unit cell. The additional requirement that all elements must map to a grid limits the available number of rectangular polygons that can be fit within the unit cell.

As FIGS. 1B, 2, and 3 illustrate simply using square shapes limits the available graytone level range. The methods of the invention contemplate using all possible rectangular polygons that fit within a unit cell and can be fabricated using a given mask design and fabrication tools. This maximizes the achievable number of graytone levels, while minimizing the resulting mask data files and mask fabrication times. In one embodiment, the methods of the invention provide an optimized number of generally rectangular elements, which are applicable to suitable mask fabrication techniques.

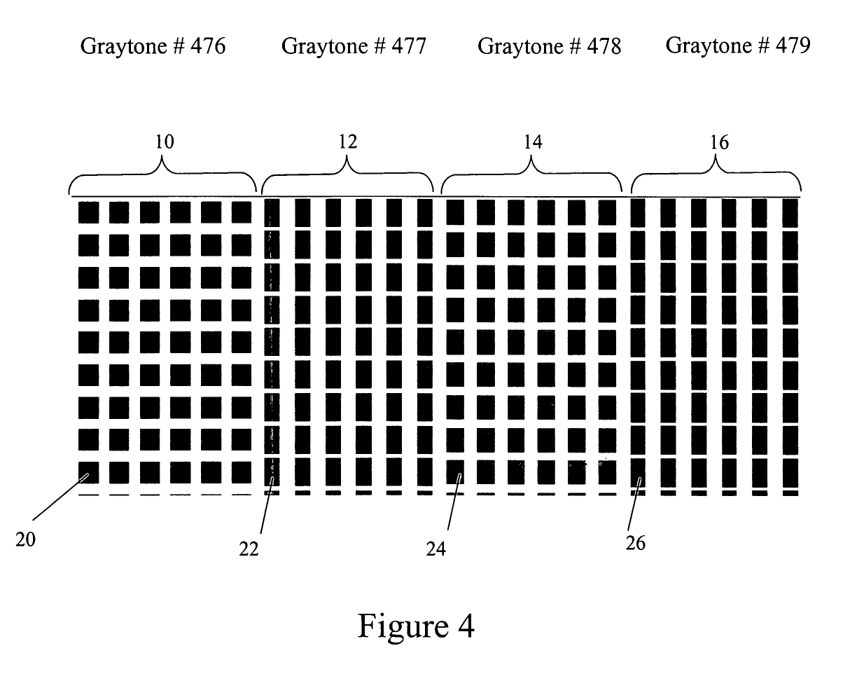

FIG. 4 illustrates adjacent graytone levels from a mask layout having a 0.56 μm unit cell size designed for use with a 10× i-line (365 nm) stepper. None of the unit cells shown in the figure are completely filled. In the layout portion shown, each graytone level has a width of 6 unit cells. However, in one embodiment any single unit cell can be used to represent one graytone level. The four sections of graytone levels 10, 12, 14, and 16 correspond to graytone numbers 476, 477, 478, and 479 respectively. These four graytone levels represent a small fraction of the available 725 levels derived from FIG. 3. Individual fill elements 20, 22, 24, and 26 are disposed in sections 10, 12, 14, and 16. Each of these fill elements corresponds to each of the four respective graytone levels.

The unit cell fill fraction for the different levels 10, 12, 14, and 16 is 40.17%, 40.46%, 40.53, and 40.63% respectively. These percentages correspond to the ratio of the areas of a fill element rectangle 20, 22, 24, and 26 and the unit cell area, (0.56² μm²). In light of a monotonic increase in fill factor, increasing the available number of graytones for a given mask design results in large disparities in the aspect ratio of the rectangular fill elements. The different aspect ratios make it difficult to determine which grayscale level is higher or lower based upon simply visually inspecting the pattern. Without additional information, a visual inspection of FIG. 4 does not necessarily reveal a graytone pattern that increases from left to right. This counterintuitive aspect of the invention underscores the significance of its methodology.

A mask produced using the fill elements shown in FIG. 4 and derived from the data in FIG. 3 would generate the desired intensity pattern in the photoresist layer. Therefore, although the arrangement of areas may not be visually discernable as distinct grayscale levels, a mask produced using the claimed approach benefits from the increase in graytone levels. Again it is the subtleness of the area changes and the unconventional arrangement of shapes that provides the beneficial increase in grayscale number.

In contrast, in FIG. 1A and 1B a pattern of increasing graytone levels is clearly visible. However, the increased visibility of the grayscale in FIGS. 1A and 1B comes at the cost of fewer graytone levels, which limits the complexity and smoothness of the resultant fabricated structures.

The techniques discussed herein recognize that rectangular fill elements either alone or in combination with square fill elements offer certain advantages. This follows because a rectangular fill element positioned substantially at the center of a unit cell corresponds to a unique fill fraction without introducing aberrant diffraction effects. More importantly, the area of a square increases faster than that of a rectangle, given an incremental increase in one dimension. If a square of side S increases the length of one side to (S+1), the area increases to (S+1)². However, if a rectangle of length (L) and width (W), increases the length to (L+1), the area only increases to L(L+1). Thus, more rectangular elements corresponding to unique fill fractions (graytone levels) can be fit within a unit cell of area p² than corresponding square elements. This concept is visually represented in FIGS. 3 and 4.

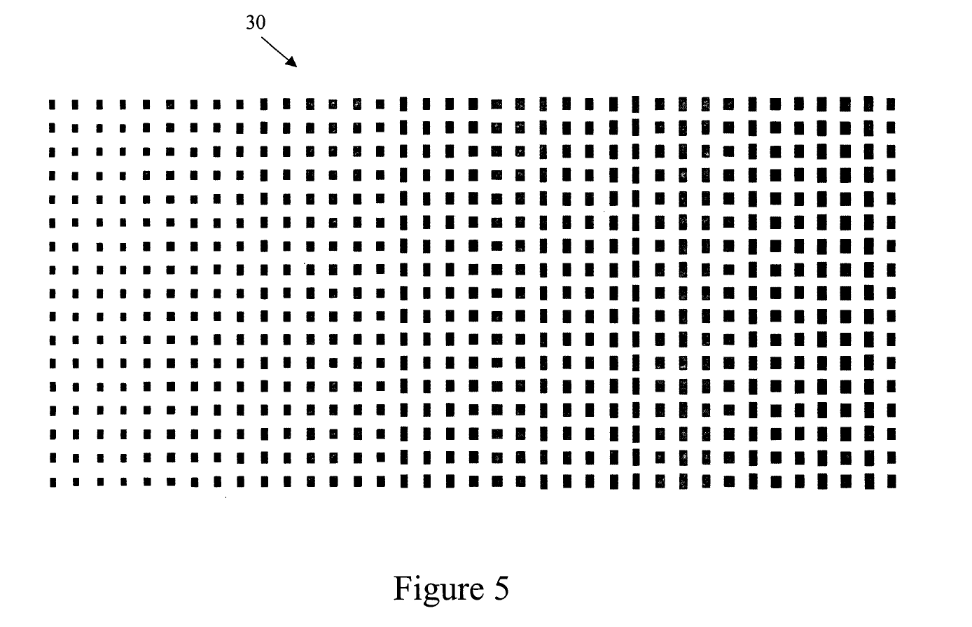

FIG. 5 illustrates a mask layout 30 prepared using the fill element selection techniques of the invention. This mask layout 30 is designed for generating a wedge structure. The mask layout has a 0.56 μm unit cell and is designed for use with 10× i-line (365 nm) stepper. Each graytone level in the wedge design is one unit cell in width. The thin region of the wedge is on the left (low fill factor) and the thick region is on the right (high fill factor). The wedge is comprised of unit cells with monotonically increasing fill factor. This example can be contrasted with the wedge portion 1 of FIG. 1A. In FIG. 1A, when moving across the taper from left to right the maximum fill element size has almost been reached. While in FIG. 5, a greater number of grayscale levels are shown and the maximum fill element size is not close to being achieved.

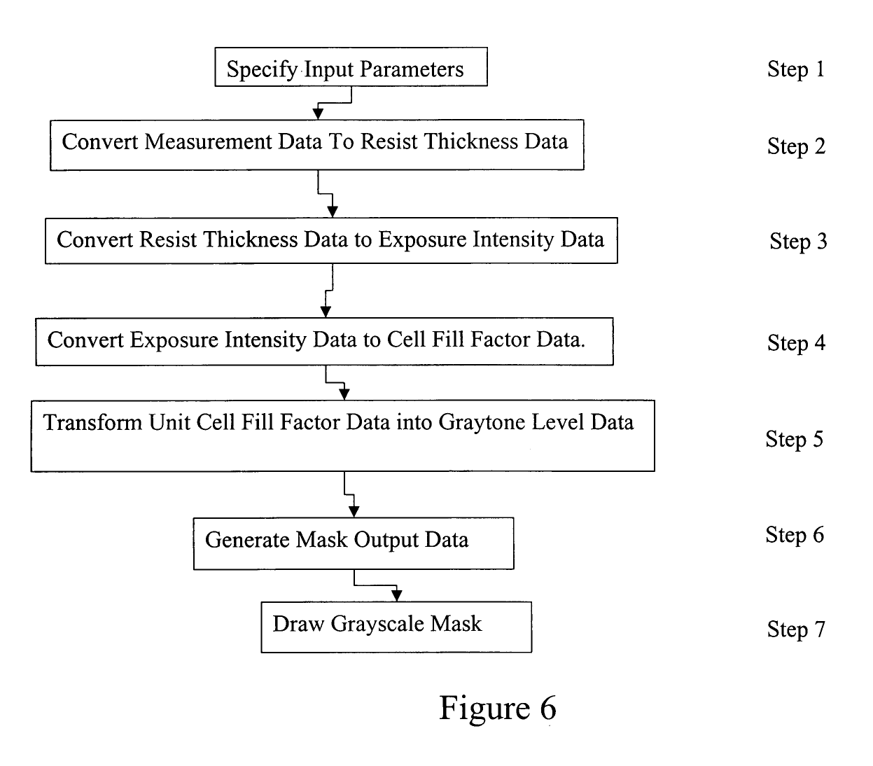

Now that various examples have been introduced, some of the techniques of the claimed invention can be discussed in more detail with respect to FIG. 6. FIG. 6 illustrates a method of designing a grayscale mask incorporating an increased number of grayscale levels. Initially, some of the input parameters that relate to the construction of the mask and the related fabrication process are specified. (Step 1)

There are number of input parameters that can be specified when designing a grayscale mask. In part, various input parameters can be derived from the final geometry of the part that is being fabricated. A grid may be superimposed on the three-dimensional model of the structure being fabricated. At each point on the grid a height measure may obtained. These height values can be used to generate a two dimensional array or matrix (m×n) or (n×n). Each element in the array equals one unit cell on mask, while the value of each array element equals a final device design height. The matrix positions of the array may correspond to a position on the grid where the height measure was obtained.

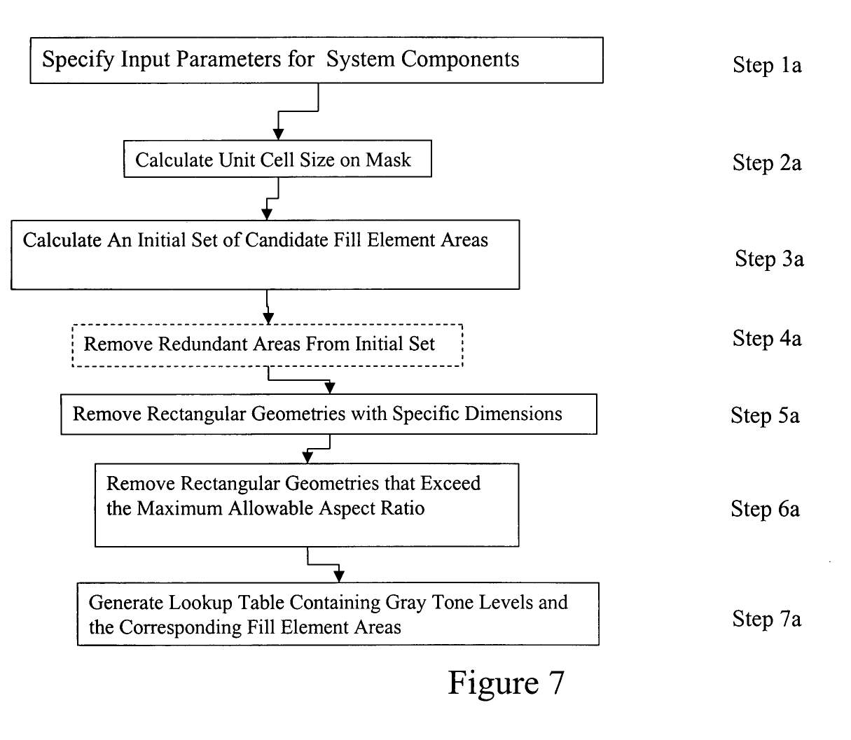

Other input parameters are used that are independent of the geometry of the part design proposed for fabrication. One such input parameter includes empirical (or theoretical) data showing resist-to-substrate selectivity as a function of etch depth. The ratio of varying etch rates, such as the etch rates of a photoresist region compared with the etch rate of a substrate, is known as the selectivity. Empirical (or theoretical) data showing resist contrast (resist thickness vs. exposure dose) can also be used as an input parameter to the graytone level selection and mask design processes. The maximum exposure dose for the photoresist is another candidate input parameter. The maximum exposure dose is the level of light that causes substantially all of the photoresist material to be removed during development. Additionally, the unit cell size on the mask can be an input parameter. A theoretically derived lookup table of gray tone levels including fill factor and fill element dimensions may also be used as input parameters in different stages of the mask design process. The details of generating suitable look up tables are discussed below with respect to FIG. 7.

Still referring to FIG. 6, in the next phase of the mask design process, various types of data conversion are carried out. In various embodiments, it understood that suitable data can be used to fabricate a particular structure such that conversion steps are not necessitated. Additionally, the different conversion steps may be done individually or all at once within a suitable processor, ASIC, or other computational device. Generally, the steps of designing the mask involve developing data relationships based upon how light projected through the mask will affect a suitable photoresist layer.

In FIG. 6, various input parameters were specified. Assuming that an array of measurement data for the desired structure was specified, that data can be converted to corresponding photoresist thickness data. (Step 2) In one embodiment, the measurement data includes height measurements of the desired structure. Photoresist and substrate selectivity data can be used to generate the photoresist thickness required to produce the desired device geometry.

In turn, the photoresist thickness data obtained above can be converted to exposure intensity data. (Step 3) In one embodiment, this intensity data is organized in a two-dimensional array or matrix. Knowledge of how the photoresists behaves when exposed to electromagnetic radiation such as visible or UV light, facilitates the calculation of the exposure levels needed to chemically transform the resist. Photoresist contrast curves can be used to achieve this conversion in some embodiments.

Exposing a photoresist layer to light of a suitable λ, causes the layer to undergo chemical changes based upon the resist's characteristics. Thus, regulating the photoresist's exposure to light through the mask results in portions of the photoresist receiving a controlled level of exposure. Developing the chemically altered photoresist results in a resist layer that includes a plurality of diverse three-dimensional structures disposed as islands on the substrate. In some embodiments, these structures exhibit a mesa shape. These structures are disposed within a unit cell on the surface of the substrate.

Still referring to FIG. 6, once the intensity data for transforming the photoresist layer is indirectly derived from the design of the final part, another conversion step is performed. The intensity data is converted to unit cell fill fraction data (alternatively referred to as the fill factor). (Step 4) This data can also be represented in an array or matrix. In one embodiment, this conversion uses the unit cell size, maximum exposure dose data and the fact that light intensity is proportional to fill fraction. As was discussed above, the fill fraction is derivable from the area of shaped disposed within a particular unit cell.

The unit cell fill factor data is transformed into a set of graytone data. (Step 5) In one embodiment, a gray scale lookup table is used to replace each fill factor element in the two dimensional array with the closest matching gray tone level in the lookup table. In some embodiments, the graytone level data corresponds to a set of distinct square and rectangular shapes of different areas. The details of generating this graytone data set are discussed in more detail with respect to FIG. 7.

Accordingly, this graytone data set is used to generate mask output data suitable for use by mask writing software. (Step 6) This mask output data can be scripts for reticle CAD software. However, the mask output data can be adapted for any type of mask writing software or hardware. In one embodiment, L-Edit (Tanner Research, Inc., 2650 East Foothill Boulevard Pasadena, Calif. 91107) is used as the software package. Once the mask output data is processed by the mask writing software, a grayscale mask suitable for fabricating the structure of interest is written. (Step 7)

Various metallic and non-metallic materials can be used to form the regions disposed on the mask. In some embodiments, chrome is used to form the regions that define the mask's patterned regions. However, any suitable patternable material used in the preparation of semiconductor masks is appropriate. In some embodiments, the mask is a substantially light transmitting substrate. In one embodiment, the mask includes a quartz substrate.

FIG. 7 illustrates a method of augmenting the number of available graytone levels. In part, the method generates distinct unit cell fill element geometries that can be used in a give grayscale mask design. Aspects of the method illustrated in FIG. 7 can be used to generate the look up table of graytones used in the method described with respect to FIG. 6.

Various components are combined to form a grayscale lithography based fabrication system. Some of these components include, but are not limited to the optical projection system (typically a stepper), a mask write tool, and the materials that are used to create the mask. Thus before the available number of graytones can be augmented for a given mask design, some of the specific parameters associated with these components need to be specified. (Step 1a) This follows because some of the parameters will limit what types of shapes can be written on a given mask. Some exemplary input parameters include, but are not limited to the address size on the reticle, the minimum resolvable spot size for stepper, the optical reduction of the stepper, the minimum spot size for mask write tool, the maximum allowed aspect ratio of the patterned regions on mask, the minimum resolvable gap between regions on the mask, the stepper wavelength, the stepper numerical aperture N_{A}, and the stepper coherence parameter σ.

The address size on the reticle corresponds to the basic area unit of a coordinate grid that is superimposed by the mask write tool on the mask's substrate. This mask address grid serves as the landscape by which the mask write tool orients itself when writing the mask fill elements to the substrate. This is distinct from the arrangement of unit cells, which represent a larger scale grid that is derived, in part, from the geometry of the structure being fabricated. It is possible to mathematically transform between the mask address grid and the unit cells that span a portion of a mask.

Once the various input parameters for the system have been specified, the next step is to calculate unit cell size on mask. (Step 2a) In part, the unit cell size is calculated based upon Equation 1 introduced above. The complexity of the surface of the structure being fabricated may also affect the sizing of the unit cell. Further, the capabilities of the stepper used to project light through the mask may also constrain the unit cell size. The limitations of the mask write tool being used may also restrict unit cell size.

The method also calculates an initial set of fill element areas and geometries. (Step 3a) Initially, the set of rectangular areas that will fit within a single unit cell is calculated. It is understood that these rectangular geometries also include square shapes and areas. However, conditions are established that restrict and filter out certain unacceptable shapes and areas. One such condition requires that different fill element areas are less than or equal to the area of the unit cell. Furthermore, the areas must also have vertices that are disposed on the mask address grid. That is the areas of interest must be integer multiples of the address size. This condition requires that the set of candidate shapes for use as fill elements can be written on the mask's substrate by the mask write tool.

An optional step is to remove redundant rectangular geometries from the initial set of shapes. (Step 4a) Redundant geometries include those squares and rectangles that have equivalent areas. Generally, the candidate fill element areas are centered within a unit cell. Thus, redundant geometries may include multiple rectangles with different orientations within a unit cell that share the same area. Similarly, a square element might be redundant when compared to one or more differently oriented rectangles with equivalent areas. Again this step is optional, and need not be used in ever embodiment of the invention. However, removing redundant geometries is advantageous because it simplifies the steps used to generate the graytone masks.

The techniques of the invention also contemplate filtering out certain areas based upon other criteria. Some of these criteria are determined in light of the input parameters discussed above. When establishing a set of candidate fill element areas, it is desirable to remove rectangular geometries with a dimension smaller than the minimum spot size of the mask write tool. (Step 5a) This follows because if the mask tool is instructed to write fill element regions to the mask at level of detail for which it was not designed errors will result. Further, the method illustrated in FIG. 7 also removes rectangular geometries that exceed the maximum allowable aspect ratio. (Step 6a) This step is included to prevent filled unit cells from running together during mask fabrication. If unit cells blend together because of the aspect ratios of the fill elements they contain, defects will result in the surface of the part being fabricated.

At this point in the process, the initial set of quadrilateral areas obtained in Step 3a has been reduced based upon the restrictions introduced above. In some embodiments, the set of rectangular geometries is arranged in ascending or descending order and gray tone numbers are assigned to each fill element. This facilitates generating a lookup table containing gray tone number, unit cell fill factor, and length and width dimensions for the various fill elements. (Step 7a) This results in an augmented set of graytone levels for designing a mask that can accommodate greater part smoothness and surface complexity.

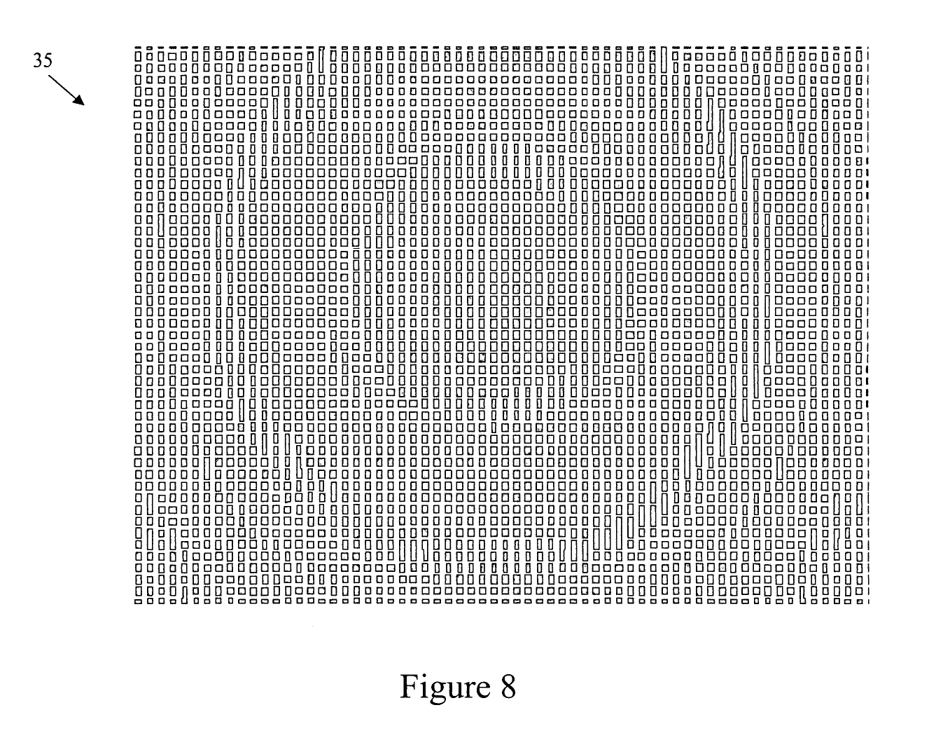

The techniques and methods discussed above can be used to increase the number of available graytones. In turn, the ability to design masks with more graytone levels expands the scope of the types of parts that can be fabricated. Various types of lenses can be fabricated using the techniques disclosed herein. Turning to FIG. 8, an exemplary mask layout 35 for a lens structure is shown. The mask layout 35 shown uses a 0.56 μm unit cell size and is designed for use on a 10× I-line (365 mn) stepper. The apex of the lens is located at the center of the image and the thickness of the lens decreases toward the perimeter of the image. The types of rectangular fill elements disposed within each unit cell were chosen to increase the number of graytone levels.

In some portions concentric bands of rectangular fill elements are shown that correspond to the surface curvature of the lens. However, in some points in the figure continuous strips of fill elements are show. The continuous strips are actually formed by partially filled unit cells. The resolution of the mask as shown does not reveal the gaps between the fill elements throughout the mask, but they do exist in the mask as fabricated. The lens surface's sensitivity to defects makes the methods disclosed herein particular suited for lens fabrication. Thus, collimating, cylindrical, diverging, square, and other types of lenses of varying size scales can be fabricating using the masks and techniques disclosed herein.

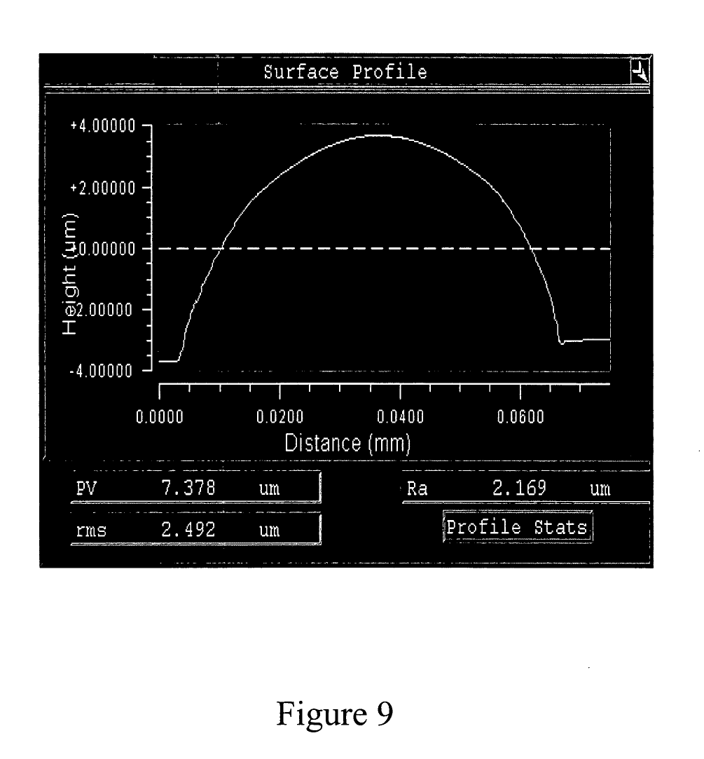

FIG. 9 shows a cross sectional surface profile of a lens structure formed in Shipley SPR220-7 photoresist using a grayscale mask and 10× i-line stepper. The surface profile of the photoresist was measured using an interferometric microscope. In fabrication methods using a reduced number of graytone levels, the surface profile would be quite different. Using less grayscale levels produces a stair case shape in the photoresist layer because of abrupt changes in photoresist heights. These abrupt changes occur because of limitations regarding grayscale number. The invention addresses this detrimental phenomenon. By increasing the number of graytones through specially selected fill element areas, the changes between photoresist structures heights is more gradual. This reduces the staircase shape and other defects. Additionally, by imposing restrictions on the aspect ratios of fill elements, partially filled unit cells do not bleed together into misshapen photoresist structures. Consequently, both lens structures and grating structures can be produced with reduced surface defects.

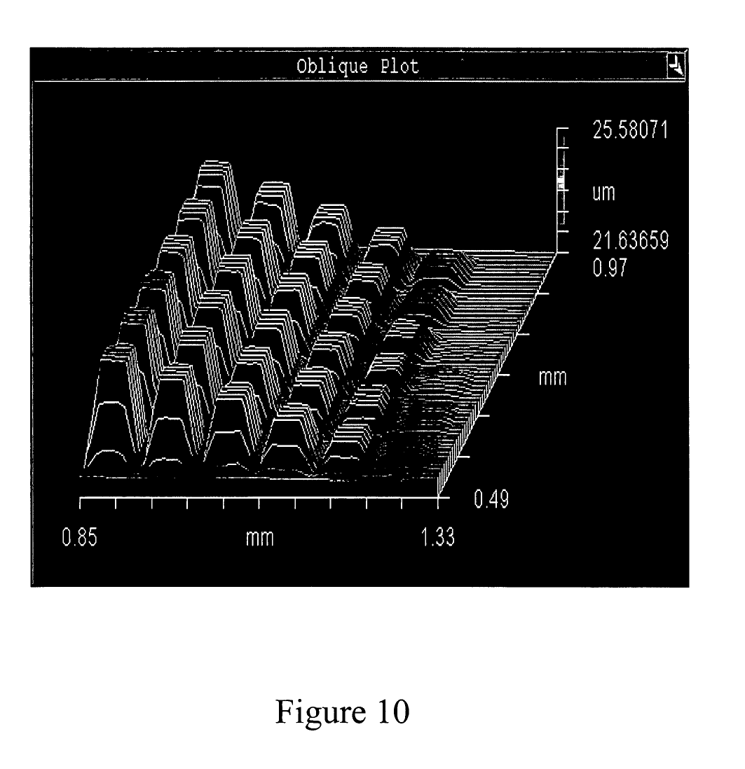

In the example of the lens in FIG. 9, the discrete graytone levels blend together to for a structure with a smooth surface. In contrast, structures can be fabricated with discontinuous heights and near vertical profiles. For example, an arrangement of mesa structures is shown in FIG. 10. These mesa structures are produced after a photoresist layer has been exposed to light through a mask designed using the techniques of the invention. The mesas were formed in Shipley SPR220-7 photoresist using a grayscale mask and 10× i-line stepper. A 6×6 array of mesas ranging from 0 to ˜4 um in height is shown. Various suitable photoresists can be used to fabricate three-dimensional structures using the grayscale augmentation techniques disclosed herein. Suitable photoresist include, but are not limited to SEPR-IO32-6 from ShinEtsu MicroSi, UV26-2.5 from Shipley, and Megaposit SPR 511 from Shipley. (Shin-Etsu MicroSi, Inc. 10028 S. 51st St., Phoenix, Ariz. 85044) (Shipley Corporation, Marlborough, Mass.)

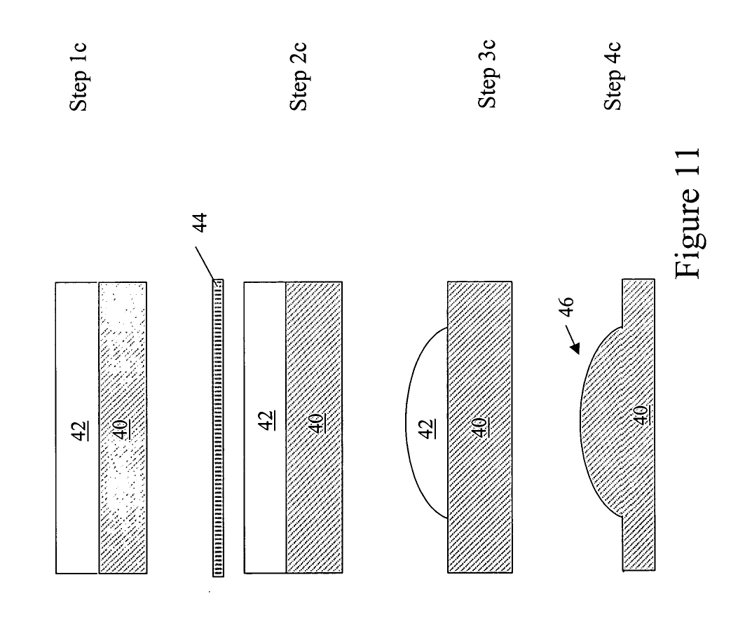

Turning to FIG. 11, some of the steps used to fabricate a three-dimensional structure are show. Initially, a substrate 40 and a photoresist layer 42 are provided. (Step 1c) Prior to this step, a suitable mask 44 would have been designed using some of the techniques discussed above. The mask 44 shown is suitable for producing a lens structure. The mask shown in FIG. 8 could be used as the mask 44 shown in Step 2c. Electromagnetic radiation is directed through the mask to selectively alter the photoresist layer 42. In different embodiments either positive or negative photoresists can be used. However, the choice of photoresist must be considered when designing the mask. Following exposure to electromagnetic radiation, the photoresist layer 42 is developed using a suitable chemical compound. (Step 3c) As a result of the development, portions of the photoresist layer 42 are removed.

Once a mask 42 has been designed based on the characteristics of the structure of interest and the photoresist structures are formed on the substrate surface, an etch process is used to shape the substrate. (Step 4c) The resultant lens structure 46 is shown following a suitable etch process. The photoresist-coated substrate may be etched with an anisotropic process that transfers the resist pattern into the underlying substrate. This transfer occurs subject to a scaling factor equal to the etch selectivity between the substrate and the photoresist. Various substrates can be used to fabricate three-dimensional structures such as lenses and gratings. Silicon dioxide, Silicon based, and Silicon-on-Insulator substrates can be used in various embodiments. However, other doped and undoped substrates can be used in various embodiments.

Various types of etch techniques known to those skilled in the art can be used to transform the arrangement of photoresist mesa structures into a final part with a desired geometry. Some specific etch processes that can be used include, but are not limited to wet etches, ion milling, and reactive ion etches. Suitable RIE etch chemistries for Silicon substrates include Sulfur Hexafluoride (SF₆) and Oxygen (O₂); Chlorine (Cl₂) and Helium (He); and Chlorine (Cl₂) and Hydrogen Bromide (HBr). Suitable RIE etch chemistries for Silicon dioxide substrates include freon based chemistries (CF₄, CHF₃, C₄F₈), Oxygen (O₂), Hydrogen (H₂) and Argon (Ar₂).

When the photoresist layer is subjected to the one of the selected etches, the photoresist is etched as well, although at a different rate. The thinner regions of photoresist are fully removed in a shorter time interval that the thicker regions of photoresist, and thereby expose underlying substrate layers at an earlier time than the substrate is exposed under thicker regions of photoresist. The depth to which the underlying substrate is etched is therefore determined by the thickness of the photoresist after being developed, the etch ratio, and the etch time. The result is that the depth of the substrate etch can be made to vary across the silicon surface in a predetermined fashion. In this way, three dimensional relief patterns can be transferred from the photoresist mesa structures to the underlying substrate layer. Thus, lenses, grating elements and other three-dimensional structures can be fabricated using the teachings of the invention.

It should be appreciated that various aspects of the claimed invention are directed to subsets and substeps of the fabrication techniques disclosed herein. Further, the terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed. Accordingly, what is desired to be secured by Letters Patent is the invention as defined and differentiated in the following claims, including all equivalents.

1. A method of fabricating a three-dimensional structure from an etchable substrate, the method comprising the steps of:
specifying a unit cell size for a plurality of unit cells, each unit cell corresponding to an area on a mask;
generating a plurality of measurement values, each measurement value corresponding to a portion of the structure, each measurement value associated with a specific unit cell;
converting the plurality of measurement values to a plurality of unit cell fill factor values;
generating a gray tone data set in response to the unit cell fill factor values, the gray tone data set comprising
a plurality of distinct rectangular areas and distinct square areas, each distinct area corresponding to a unique gray tone level,
adjusting the size and number of square and rectangular areas to increase the available number of unique gray tone levels; and
creating the mask in response to the gray tone data set such that at least a portion of the plurality of rectangular and square areas are disposed on the mask.

2. The method of claim 1 further comprising the step of etching a pattern of non-overlapping three-dimensional photoresist volumes disposed on the substrate, the pattern of photoresist volumes generated in response to the areas on the mask.

3. The method of claim 1 wherein the measurement values comprise height values measured at specific points on a surface of the three-dimensional structure.

4. The method of claim 1 wherein the step of converting the plurality of measurement values uses selectivity data, photoresist contrast data, and exposure data.

5. The method of claim 1 wherein the step of adjusting the size and number of square and rectangular areas comprises calculating at least a portion of the rectangular and square geometries that can fit within a unit cell.

6. The method of claim 5 further comprising the step of eliminating rectangular and square areas that exceed a specified aspect ratio.

7. The method of claim 5 further comprising the step of eliminating rectangular and square areas having a dimension smaller than a minimum spot size of a mask write tool.

8. The method of claim 1 wherein the photoresist volumes are mesa structures.

9. The method of claim 1 wherein the gray tone data set comprises shapes that differ in area as a result of an increase in the length or width of the of the shape.

10. A method of increasing available graytone levels for use in a lithographic process, the method comprising:
determining a unit cell size in response to a designed part geometry;
generating a set of distinct quadrilateral areas such that each area fits within a unit cell;
removing redundant quadrilateral areas from the set,
associating each graytone level with a distinct quadrilateral area; and
correlating each graytone level with a distinct unit cell fill factor.

11. The method of claim 10 wherein the set of distinct quadrilateral areas comprises a first set of square areas and a second set of rectangular areas.

12. The method of claim 10 wherein the set of distinct quadrilateral areas comprises shapes that monotonically increase in area by incrementing the either the length or width of the quadrilateral area by one unit quantity.

13. The method of claim 10 wherein all distinct quadrilateral areas that fit within a unit cell are associated with a graytone level.

14. The method of claim 13 wherein quadrilateral areas having a dimension smaller than the minimum spot size of a mask write tool are removed from the set.

15. A lens fabricated using a grayscale lithographic process, the process comprising the steps of:
generating a pattern of three-dimensional photoresist structures on a substrate using a mask, the mask comprising a plurality of regions populated by rectangular and square areas; and
etching the photoresist and substrate, thereby generating a lens.

16. The lens of claim 15 wherein the lens has a lens diameter ranging from about 5 μm to about 1 cm.

17. The lens of claim 15 wherein aspect ratios of the rectangular and square areas are restricted to reduce surface defects in the lens.

18. The lens of claim 15 wherein the required smoothness of the lens surface determines the number and size of the distinct square and rectangular areas disposed on the mask.

19. The lens of claim 15 wherein a portion of the regions are substantially concentric.

20. A diffraction grating produced using a lithography process, the lithography process comprising the steps of:
generating a mask having a periodic arrangement of a plurality of selectively filled unit cells, each unit cell partially filled with a fractional area selected from a set of square and rectangular areas, each area corresponding to a gray tone level;
depositing a photoresist layer on a substrate;
exposing the photoresist layer to radiation selectively transmitted by the areas of the mask;
developing the photoresist layer such that a periodic arrangement of photoresist
mesa structures result; and etching the mesa structures and substrate.

21. The grating of claim 20 wherein the grating spacing ranges from about 5 μm to about 1 cm.
